(19) United States
(12) Patent Application Publication
(10) Pub. No.: US 2009/0205054 A1
(43) Pub. Date: Aug. 13, 2009

(54) PROCESS FOR PROTECTING STORED OPERATING DATA OF MACHINERY OR SIMILAR EQUIPMENT

(76) Inventors: Wilfried Blotenberg, Dinslaken (DE); Ulrich Gebhardt, Schwelm (DE)

Correspondence Address: MCGLEW & TUTTLE, PC, P.O. BOX 9227, SCARBOROUGH STATION, SCARBOROUGH, NY, 10510-9227, US

(21) Appl. No.: 12/366,081

(22) Filed: Feb. 5, 2009

(30) Foreign Application Priority Data
Feb. 7, 2008 (DE) 10 2008 008 317.8

(51) Int. Cl. H04L 9/32

(52) U.S. Cl. 726/30

(57) ABSTRACT

A process is provided for protecting stored operating data of machinery or similar equipment. The operating data are stored by means of a computer system belonging to a control system or by means of a similar computer system belonging to the equipment and wherein the operating data are acquired continuously in the form of data sets and stored in a data storage medium for later analysis. A security code is generated with the storage of a data set from the currently stored operating data on the basis of parameters (k, l, m, n) of a preset determination rule and stored in the computer system. A comparison code is determined in at preset time intervals on the basis of the same determination rule from the operating data currently recorded in the data storage medium for verifying the operating data currently present in the data storage medium. The comparison code is compared with the security code generated originally, and a warning signal is generated or a protective action is triggered in a fourth step in case of a deviation between the comparison code and the security code generated originally.

### CROSS REFERENCE TO RELATED APPLICATIONS

This application claims the benefit of priority under 35 U.S.C. §119 of German Patent Application DE 10 2008 008 317.8 filed Feb. 7, 2008, the entire contents of which are incorporated herein by reference.

### FIELD OF THE INVENTION

The present invention pertains to a process for protecting stored operating data of machinery or similar equipment against manipulation.

### BACKGROUND OF THE INVENTION

Monitoring systems and protection systems for machinery and numerous other applications are increasingly provided with functions for recording operating data. The data of important parameters are acquired herefor continuously by means of sensors for the analysis of the state of the machine, converted into digital signals and stored securely in a corresponding data storage medium. Such systems for recording data operate continuously, i.e., these systems record the status of the machinery continuously during the running operation of the particular machines. Such recorded operating data therefore make it possible after the development of damage to the machine to reconstruct the process and as a result, they provide information on the possible causes of the damage that occurred.

It is common during the recording of operating data to integrate these data into data blocks and to store them as closed data sets in a data storage medium. The size of the data sets, i.e., the length of the operating time period to be acquired by a closed data set, is selected to be such that analysis is facilitated. A closed data set with operating data from an operating time period located only shortly before in time can be analyzed, for example, simultaneously with the current recording of current operating data. Closed data sets can also be copied and transferred to other computer systems. However, such closed data sets can also be deleted and hence destroyed.

It is common in engineering to close the data, for example, hourly, daily, weekly or monthly. Separate data sets are thus available for analysis for every hour, every day, every week or every month.

Furthermore, it is also common practice in engineering to name the recorded operating data by the descriptive term “historical operating data” for better understanding.

A different process, namely, a so-called event-controlled recording, is frequently employed in machinery having a plurality of measuring points, which are used in highly transient systems. As long as the machinery that is operating is running trouble-free, the operating data are overwritten after a certain operating time and older operating data are thus automatically deleted, so that only a period of, for example, one hour is always preserved. If a predetermined event occurs, e.g., a critical operating state, the automatic deletion operation is interrupted. The recorded operating data that have not yet been deleted are then stored as a data set on a secure data storage medium. The recorded operating data are thus preserved for later analysis.

A process of overwriting with an automatic operation in which older operating data are automatically deleted, which operation is associated therewith, causes the quantity of stored data to be markedly reduced while a comprehensive data stock for critical operating states is nevertheless preserved.

The recorded operating data can provide the manufacturer of the machinery with substantial assistance in proving incorrect operation and in defense against claims asserted in an unjustified manner especially in case of machinery with recorded damage that may be caused by incorrect operation of the machinery or by the fact that preset warning signals were ignored by the operating staff upon development of disturbances in the machinery. The same applies to insurance companies, which can prove a possible operating error by analyzing the recorded operating data and thus assert the loss of insurance coverage.

The operating data of machinery or similar equipment are usually recorded with PC-based computer systems. The systems commonly used in offices are normally used as the operating system. An operating staff familiar with the PC technology can therefore access the recorded operating data at any time and thus also manipulate these data. In particular, by accessing files, the operating staff, who wishes to prevent the demonstration of operating errors, has the possibility of destroying incriminating material by deleting or modifying some of the data files. The loss of the operating data of such deleted files is frequently determined only at a later point in time. It is no longer possible to prove when and by whom the files were destroyed or deleted.

The operating data are often stored on portable media. Such portable media may be personal computers, which are connected to the control system of machinery or similar equipment via a data interface. It is also possible to use a portable data storage medium in the form of a hard drive, CD-ROM, DVD or a nonvolatile semiconductor memory as a so-called flash card.

There will be further storage possibilities in the future, which can likewise be used advantageously after the necessary devices and data storage medium are made available.

### SUMMARY OF THE INVENTION

An object of the present invention is to provide a process for protecting stored operating data of machinery or similar equipment, wherein the operating data shall be largely preserved for proving manipulation.

One advantage of the present invention over the state of the art is that manipulation of stored operating data, e.g., by deleting individual data sets, is immediately recognized and reported.

According to the invention, a process for protecting stored operating data of machinery or similar equipment is provided for this purpose, wherein the operating data are stored by means of a computer system belonging to a control system of the machinery or by means of a similar computer system belonging to the equipment/machinery and wherein the operating data are acquired continuously in the form of data sets and are stored in a data storage medium for later analysis. A security code is generated with the storage of a data set, such security code being generated from the stored data or the data to be stored in such a form that numbers are selected from the operating data by a determination rule provided with variable parameters k, l, m, n and are used as part of the security code. The parameters k, l, m, n determine which digit of an operating parameter shall be selected from which data sets and added to the security code. The security code is then stored in the computer system. A comparison code is then determined in another step from the recorded operating data currently present in the data storage medium for verifying the operating data currently present in the data storage medium in the computer system at preset time intervals on the basis of the same determination rule. The comparison code is compared in another step with the security code generated originally in the computer system. Finally, a warning signal is generated or a protective action is triggered in a further step in case of a deviation between the comparison code and the originally generated security code.

The machinery is advantageously changed over to a safe operating state with the onset of the warning signal or is stopped by a protective action triggered by the warning signal.

The preset determination rule is variable. The parameters of the determination rule shall have been preselected for this as fixed parameters or determined by a random generator or determined from stored operating data.

The security code is advantageously checked every time the machine program is started, each time the machinery is started or at regular time intervals.

As an alternative, the security code is advantageously checked at times preset by a random generator or upon an external trigger command.

A process with a corresponding coding technique, which makes the destruction or manipulation of operating data immediately visible, will be explained below. The various features of novelty which characterize the invention are pointed out with particularity in the claims annexed to and forming a part of this disclosure. For a better understanding of the invention, its operating advantages and specific objects attained by its uses, reference is made to the descriptive matter in which preferred embodiments of the invention are explained.

### DESCRIPTION OF THE PREFERRED EMBODIMENTS

According to the process, a security code is generated in a step from current operating data by a computer system, which is connected to the control system of the machinery or is part of the control system, according to a preset determination rule and stored in the computer system. The security code is polled at the start of the machine program for controlling the machinery, at the start of the machinery or at regular time intervals or in case of predetermined events.

A comparison code is determined in another step at preset time intervals for verifying the operating data currently present in the data storage medium on the basis of the preset determination rules from the continuously recorded operating data currently present in the data storage medium. The time intervals can be set as fixed intervals or made dependent on a predetermined event, e.g., type of parameter or machine start.

The comparison code determined is compared in another step with the security code generated originally. Should the current comparison code not agree with the security code stored in the computer system of the machinery, a warning signal is generated or a protective action linked with the onset of the warning signal is triggered in a further step.

As an alternative, the machinery can be changed over to a safe operating state with the triggering of a warning signal or another massive intervention, such as shutting down of the machinery as a preventive protective action, may be performed in the operation of the machinery. An automatically generated warning signal may also be sent to the manufacturer of the machine or to an institution specified by the manufacturer of the machine.

The security code generated is formed according to a preset determination rule from the stored operating data of the machinery. To form the security code, the mth operating variable is preferably selected from every nth file of the machinery and the lth digit is read therefrom from the kth operating parameter and combined with or added to the security code. The security code consequently consists of a combination of numbers, to which additions are continuously made.

For example, a set of operating data of the machinery shall be recorded every minute and a new data set with operating data shall be stored weekly as a file. The parameters shall be preset as follows: Parameter n=5, parameter k=125, l=3, m=ultimate compressor pressure; i.e., the 125th value is read each time from every 5th file from the values of the operating variables with the ultimate compressor pressure and the third digit therefrom is added to the security code. The recording was begun in a predetermined calendar week, for example, in calendar week 14.

The fifth file for the 5th week after the start of recording is started in calendar week 18, parameter n=5. The 125th operating parameter, parameter k=125, is entered on Monday at 02:04 a.m. Number 6 is added to the security code from the value of, e.g., 17.65 bar measured for the ultimate compressor pressure as an operating variable at the said point in time corresponding to the third digit, parameter 1=3.

Number 5 is added to the security code as the third digit in calendar week 23 from the value of the ultimate compressor pressure of, e.g., 14.55 bar measured on Monday at 02:04 a.m.

Accordingly, number 6 was added to the security code in calendar week 18, whereas number 5 was added in week 23. The process is continued until the maximum number of digits of the security code is reached, for example, 100 digits. The first number of the security code, i.e., number 6 from the Monday of calendar week 18, is then deleted according to the first-in first-out principle (FIFO principle), while the newly determined number is added at the end of the security code.

The security code is stored within the central unit or the Central Processing Unit or CPU of the machine control at a location not accessible from the outside. Each time a checking is performed by comparing the security code with the comparison code, the stored security code is compared with the comparison code currently determined according to the same determination rule. Execution of the control program is continued in case of agreement, and a corresponding warning signal is generated otherwise. In addition, provisions are advantageously made as a protective function for switching off the machine on the basis of the warning signal triggered.

The security code for the first start-up can be generated in different manners. The data storage medium is preferably supplied with a minimum number of files, which permit generation of the security code, or a start code is generated, with which the equipment is shipped.

The storage locations of a data storage medium are usually empty at the beginning of a data recording, i.e., “0” is written to them. A simple manner of a first start-up is to immediately apply the determination rule to form the security code with the start-up of the machinery. The immediate application will cause the security code to consist at first of mere zeroes only and the protective mechanism to show its full effect after some operating time only, which is usually noncritical in case of new machinery, since new machinery is often started up by operating staff of the manufacturer of the machine, so that the data protection does not have to be active during this first start-up anyway.

In case of machinery in which the customer carries out the first start-up alone, the data storage medium may be filled with dummy data of, for example, a previous project or with data of the test phase run in the manufacturer's plant. The security code is generated in this case in exactly the same manner as if these data had been recorded during the machine run time.

In another embodiment of the process, the parameters k, l, m, n of the determination rule are made variable by a random generator. A set of parameters must now be stored in addition to each digit of the security code to make it possible to use the same parameters when generating the comparison code. The parameters shall be stored in a hidden area of the data storage medium or sent to the manufacturer of the machine via e-mail or SMS or in another electronic manner in order for these parameters to be stored independently.

As an alternative, the parameters themselves are generated from operating data.

Should an operator manipulate the recorded data by deleting, for example, individual files or by replacing them with other values, the comparison code generated currently will no longer agree with the security code stored in the machine control. The machine control will then trigger a corresponding warning and, among other things, shut down the machine as a protective action.

While specific embodiments of the invention have been shown and described in detail to illustrate the application of the principles of the invention, it will be understood that the invention may be embodied otherwise without departing from such principles.

What is claimed is:

1. A process for protecting stored operating data of machinery and equipment, the process comprising:
storing operating data by means of a computer system belonging to a control system of the machinery or by means of a similar computer system belonging to the equipment including continuously acquiring operating data in the form of data sets and storing the data sets in a data storage medium for later analysis;
generating a security code with the storage of a data set from the operating data currently stored on the basis of parameters (k, l, m, n) of a preset determination rule and stored in the computer system;
determining a comparison code at preset time intervals on the basis of the same determination rule from the recorded operating data stored in the data storage medium for verifying the operating data currently present in the data storage medium;
comparing the comparison code with the security code generated originally; and
generating a warning signal or triggering a protective action in case of a deviation between the comparison code and the security code generated originally.

2. A process in accordance with claim 1, wherein the machinery or similar equipment is shut down as a triggered protective action.

3. A process in accordance with claim 1, wherein the parameters (k, l, m, n) of the determination rule for the security code and the comparison code are formed as fixed or variable parameters.

4. A process in accordance with claim 3, wherein the parameters (k, l, m, n) of the determination rule for the security code and the comparison code are determined by a random generator.

5. A process in accordance with claim 4, wherein the parameters (k, l, m, n) of the determination rule are stored with the operating data and the comparison code is generated with the same parameters.

6. A process in accordance with claim 5, wherein the parameters (k, l, m, n) are stored in a hidden area of the data storage medium or are sent to the manufacturer of the machine by remote data transmission and are thus stored independently.

7. A process in accordance with claim 6, wherein the parameters (k, l, m, n) of the determination rule are coded.

8. A process in accordance with claim 3, wherein the parameters (k, l, m, n) of the determination rule for the security code and the comparison code are determined from stored operating data.

9. A process in accordance with claim 1, wherein a comparison of the comparison code and security code is performed at the start of the machine program.

10. A process in accordance with claim 1, wherein a comparison of the comparison code and security code is performed every time the machinery is started up.

11. A process in accordance with claim 1, wherein a comparison of the comparison code and security code is performed in preset operating states.

12. A process in accordance with claim 1, wherein a comparison of the comparison code and security code is performed at regular time intervals.

13. A process in accordance with claim 1, wherein a comparison of the comparison code and security code is performed at times preset by a random generator.

14. A process in accordance with claim 1, wherein a comparison of the comparison code and security code is performed upon an external trigger command.
